(19) United States
(12) Patent Application Publication
(10) Pub. No.: US 2007/0089301 A1
(43) Pub. Date: Apr. 26, 2007

(54) Carving apparatus

(76) Inventors: David A. Arias, Virginia Beach, VA (US); Jack Coe, Florence, KY (US)

Correspondence Address: COOLEY GODWARD KRONISH LLP;ATTN: PATENT GROUP, Suite 500, 1200 - 19th Street, NW, WASHINGTON, DC, 20036-2402, US

(21) Appl. No.: 11/255,180

(22) Filed: Oct. 21, 2005

(51) Int. Cl. B26B 7/00

(52) U.S. Cl. 30/277.4

(57) ABSTRACT

An apparatus, comprising a handle assembly including a drive motor and a drive pin; and an adapter configured to removably couple to the handle assembly, the adapter including a drive connector, a gear coupled to the drive connector, and a tool coupled to the gear, the drive connector configured to couple to the drive pin, the tool having a plurality of substantially blunted cutting surfaces, the drive motor being configured to cause movement of the tool such that the tool can be used to cut through a pumpkin shell.

### BACKGROUND

The invention relates generally to tools used for carving the shell and/or skin of fruits and/or vegetables. Such tools can include, for example, an apparatus for carving pumpkins.

Known techniques for carving pumpkins include the use of manual tools, such as knives and small hand-saws. Pumpkin carving can often involve the carving of an intricate, complex design, which can require multiple steps and the use of multiple different tools. Using manual tools to carve such intricate patterns, even those tools specifically designed for pumpkin carving, can be a time-consuming and laborious process.

Other known carving techniques include the use of motorized tools, such as motorized drills and saws. Again, even with such motorized tools, which can relieve some of the problems associated with manual tools, multiple tools may still be necessary to achieve a desired carving design or pattern.

Thus, a need exists for a motorized carving tool that can perform a variety of different functions and increase the ease of carving into a pumpkin shell.

### SUMMARY OF THE INVENTION

An apparatus includes a handle assembly having a drive motor and drive pin, and an adapter configured to be removably coupled to the handle assembly. The adapter includes a drive connector, a gear coupled to the drive connector, and a tool coupled to the gear. The drive connector is configured to couple to the drive pin. The tool has a plurality of substantially blunted cutting surfaces. The drive motor is configured to cause movement of the tool such that the tool can be used to cut through a pumpkin shell.

### BRIEF DESCRIPTION OF THE DRAWINGS

The invention is described with reference to the accompanying drawings. In the drawings, like reference numbers indicate identical or functionally similar elements.

FIG. 1 is a schematic illustration of a carving apparatus according to an embodiment of the invention.

FIG. 2 is a front view of a carving apparatus according to an embodiment of the invention.

FIG. 3 is a front view with a partial cut-away portion of the carving apparatus of FIG. 2.

FIG. 4 is an exploded view of a portion of the carving apparatus of FIG. 2.

FIG. 5 is an end perspective view of a handle assembly according to an embodiment of the invention.

FIG. 6 is an end perspective view of an adapter according to an embodiment of the invention.

FIG. 7 is a front view of an adapter according to an embodiment of the invention.

FIG. 8 is a front view of a carving apparatus according to an embodiment of the invention.

FIG. 9 is an exploded view of a portion of the carving apparatus of FIG. 8.

FIG. 10 is an illustration of a carving apparatus according to an embodiment of the invention shown in use carving a pumpkin.

FIG. 11 is front view of an adapter according to another embodiment of the invention.

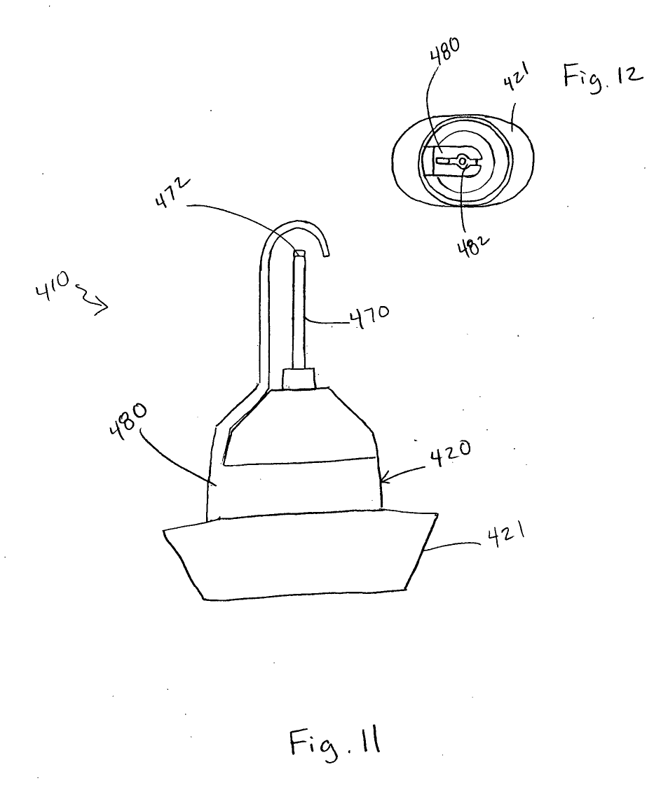

FIG, 12 is a top view of the adapter shown in FIG. 11.

### DETAILED DESCRIPTION

A carving apparatus includes a handle assembly and at least one adapter that can be coupled to the handle assembly. The handle assembly includes a drive motor coupled to a drive pin. The adapter includes a drive connector configured to matingly couple to the drive pin. A gear assembly is coupled to the drive connector, and a tool is coupled to the gear assembly. Each adapter can have a different type of tool, but each tool includes at least one substantially blunted cutting-surface configured to cut through, or modify, the shell of a pumpkin or other like object. For example, the tool can be in the form of a router bit, a drill, a saw blade, or other suitable configuration. The adapter is configured to be easily coupled to and removed from the handle assembly.

A kit can be provided that includes a handle assembly and one or more adapters. A kit can include, for example several adapters each having a different type of tool. The variety of tools provided in a kit can allow a user to select a particular tool to perform a particular desired cutting function. The easy coupling and removability of the adapters to the handle assembly provide the user with a multi-functional tool that is also easily reconfigured for different uses.

In one embodiment, an apparatus includes a handle assembly having a drive motor and drive pin, and an adapter configured to be removably coupled to the handle assembly. The adapter includes a drive connector, a gear coupled to the drive connector, and a tool coupled to the gear. The drive connector is configured to couple to the drive pin. The tool has a plurality of substantially blunted cutting-surfaces. The drive motor is configured to cause movement of the tool such that the tool can be used to cut through a pumpkin shell at less than or equal to a power threshold of 20 horsepower.

The term “substantially blunted cutting-surfaces” as used herein describes a type of cutting surface that is capable of cutting through the shell or skin of a pumpkin or like object, while at the same time is sufficiently blunted such that the surfaces cannot cut through hard materials, such as wood or metal.

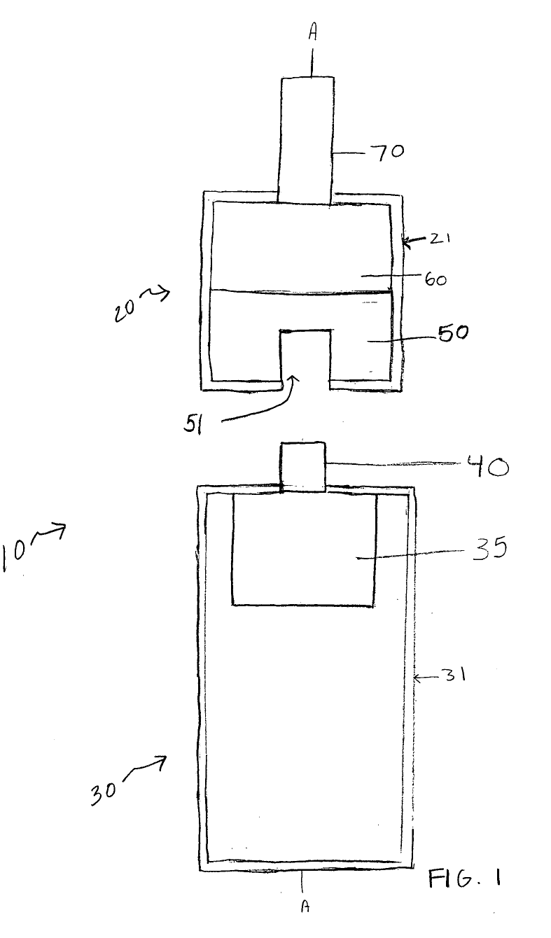

FIG. 1 is a schematic illustration of an apparatus according to an embodiment of the invention. An apparatus 10 includes a handle assembly 30 and an adapter 20 configured to be removably coupled to the handle assembly 30.

The handle assembly 30 includes a drive motor 35, and a drive pin 40 coupled to the drive motor 35. The drive pin 40 defines an axis A along which drive pin 40 is coupled to the drive motor 35. The drive motor 35 can be coupled to a power source (not shown in FIG. 1), such as a battery pack. The handle assembly 30 also includes a housing 31 that substantially encloses the interior portions of the handle assembly 30. In some embodiments, the housing 31 includes a keyway (not shown in FIG. 1) that can matingly engage with a flange (not shown in FIG. 1) disposed on the adapter, which is described in more detail below.

The drive motor 35 can be coupled to the housing 31 using, for example, threaded fasteners, straps, snaps, or other suitable methods. The drive motor 35 is configured to drive the drive pin 40 at a power threshold that is less than the power threshold of a construction-grade power tool. For example, in one embodiment, the drive motor 35 is configured to rotate the drive pin 40 at a rotational speed of less than or equal to 13,800 rpm. The low rotational speed of the motor can minimize the vibration in the handle assembly, which can facilitate better control of the tool by a user and improved accuracy during cutting or carving.

As stated above, the drive motor 35 is configured to be coupled to a power source. The power source can be, for example, a disposable or rechargeable battery or battery pack, or an electrical adapter, such as an AC adapter. In another embodiment, the power source can be a solar cell pack.

The adapter 20 includes a drive connector 50, a gear assembly 60, and a tool 70. The adapter 20 can also include a housing 21 that substantially encloses the interior portions of the adapter 20. The gear assembly 60 can include one or more gears; the particular number of gears can depend on the particular adapter embodiment. The housing 21 is configured to removably couple the adapter 20 to the handle assembly 30. In one embodiment, the adapter 20 includes a flange (not shown in FIG. 1) that matingly couples to a keyway (not shown in FIG. 1) on the housing 31 of the handle assembly 30. Each embodiment of the adapter 20 can include, for example, a different tool 70. Each embodiment of adapter 20 also can include a different configuration of some of the components of the adapter 20, as appropriate for a given tool 70 and as will be described in more detail below.

The drive connector 50 defines an opening 51 that matingly receives the drive pin 40 of the handle assembly 30. For example, the drive pin 40 can have a hexagon cross-section that mates with a corresponding hexagon cross-section defined by the opening 51 of the drive connector 50. In another embodiment, a drive connector can define an opening having a substantially cylindrical cross-section that receives a drive pin that has a corresponding substantially cylindrical shape.

The drive connector 50 can also include a geared portion (not shown in FIG. 1) on an end opposite the opening 51. In such an embodiment, the geared portion can engage the gear assembly 60. When the apparatus is actuated, the drive motor 35 causes the drive pin 40 to rotate, which in turn causes the drive connector 50 in the adapter 20 to rotate. As the geared portion of the drive connector 50 rotates, the gear assembly 60 is engaged. The gear assembly 60 can include a variety of components including one or more gears. The gear(s) can be one or more different types of gears such as a worm gear, a bevel gear, a spur gear, or a helical gear. Any other gear or gears may be used, and the above examples are merely presented as illustrative. When the gear assembly 60 is actuated, it causes the tool 70 to either rotate or move in a back-and-forth direction (i.e., longitudinally in a direction substantially along the axis A) depending on the particular adapter embodiment.

The tool 70 is coupled to the gear assembly 60. The tool 70 has a portion that is disposed inside the housing 21 and a portion that is disposed outside the housing 21 substantially along the axis A. In one embodiment, the tool 70 has a drill bit configuration. In another embodiment, the tool 70 has a saw blade configuration, and in another embodiment, the tool 70 has a router bit configuration. The tool 70 can also have a variety of other different shapes and sizes. Thus, other suitable tool configurations may be incorporated into the adapter 20, and the above examples are merely illustrative. The tool 70 can include one or more blunted cutting-surfaces (not shown in FIG. 1). The blunted cutting-surfaces are configured with a surface sufficiently sharp to cut through the shells of fruits or vegetables, such as a pumpkin, but substantially blunted such that the cutting surfaces cannot cut hard materials such as, for example, wood or metal. Also, because the drive motor 35 is configured to drive the drive pin 40 with substantially low torque, the tool 70 can cut through a pumpkin shell at less than or equal to a power threshold of about 20 horsepower. In some embodiments the torque of the tool 70 is approximately 0.013 foot-pounds and in other embodiments the torque is approximately 50 foot-pounds. In some embodiments the power threshold of the tool 70 is approximately 0.035 horsepower. In other embodiments the power threshold is approximately 1 horsepower, while still others it is 10 horsepower. The lower power threshold and lower torque of carving apparatus 20 can reduce potential incidental injuries to a user of the apparatus 20.

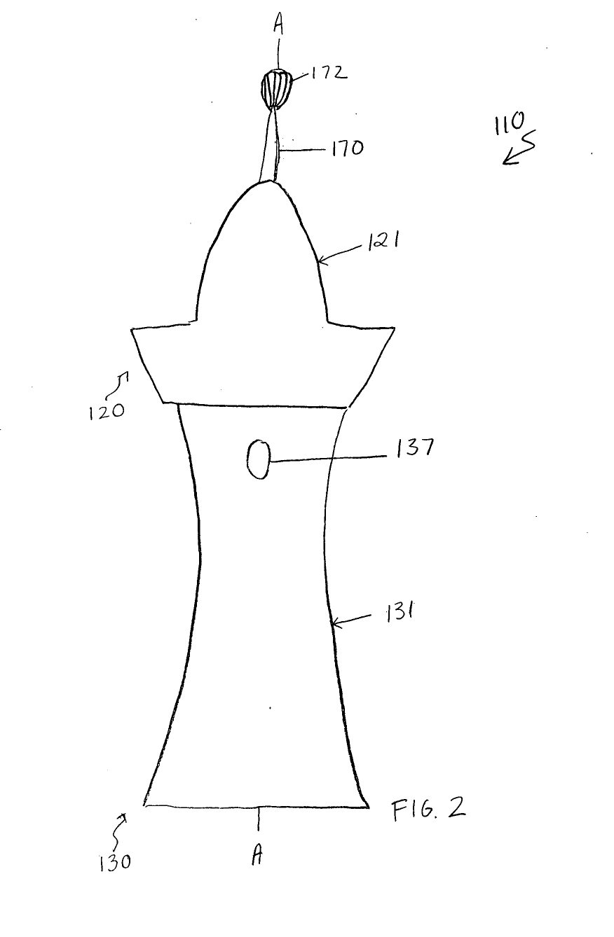

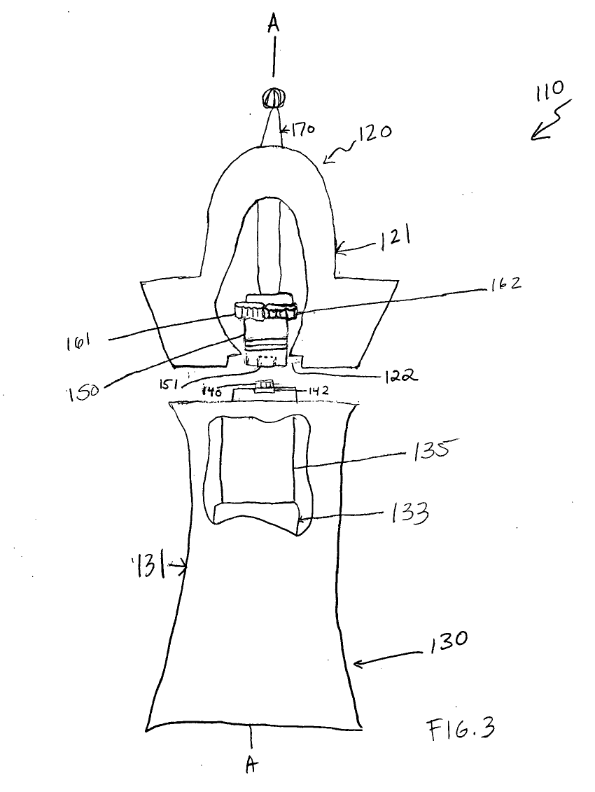

FIGS. 2-6 illustrate an apparatus 110 according to an embodiment of the invention. An apparatus 110 includes a handle assembly 130 and an adapter 120 removably coupled to the handle assembly 130. The handle assembly 130 includes a housing 131, and an actuator switch 137 disposed on an outer surface of the handle assembly 130 that can be used by a user to activate and deactivate the apparatus 110. A drive motor 135, and a drive pin 140 coupled to the drive motor 135 are disposed within the housing 131, as shown in a cut-away portion of FIG. 3. The handle assembly 130 also includes a power source 133 in the form of a battery pack. The actuator switch 137 is coupled to the power source 133 and can include an on/off function, a forward/reverse function or other suitable functions for such devices.

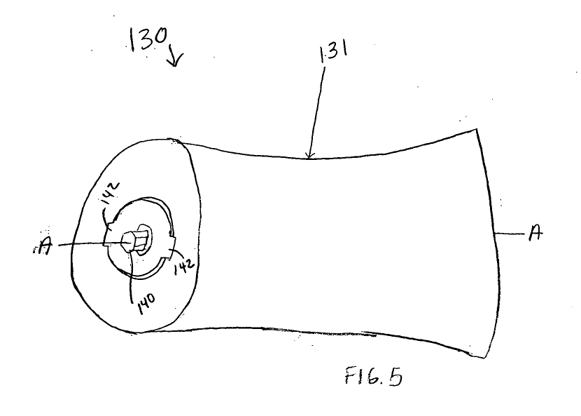

The housing 131 includes one or more flanges 142, as shown in FIG. 5. The flanges 142 are disposed above a top surface of the housing 131 and are used to removable couple the adapter 120 to the handle assembly 130 as described below. The housing 131 can include one or more components and is configured to substantially enclose the interior components of the handle assembly 130.

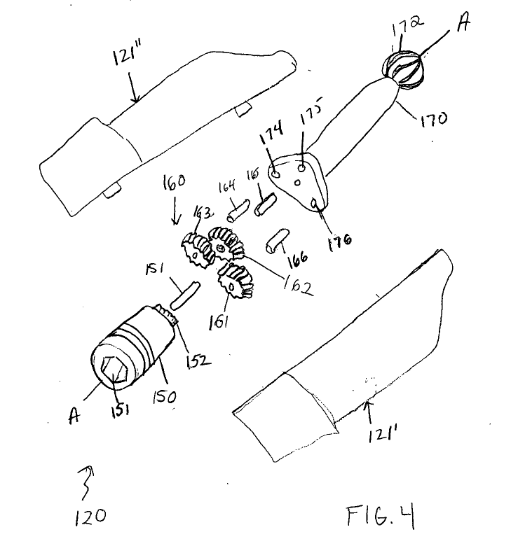

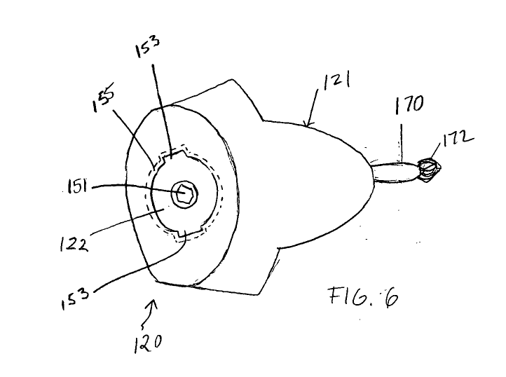

The adapter 120, as shown in FIGS. 3 and 4, includes a housing 121. As shown in FIG. 4, which is an exploded view of the adapter 120, the housing 121 includes two portions 121′, 121″ that are configured to be coupled together to substantially enclose the interior components of the adapter 120. Any suitable coupling methods can be used to couple the portions of the housing 121, such as snap fit connections, friction fit, threaded fasteners and the like. The housing 121 of the adapter 120 also defines a keyway 122, as shown in FIG. 6. The keyway 122 includes a recess 155 configured to slidably and removably receive the flanges 142 of the handle assembly 130. The keyway 122 also includes at least one notch 153 into which the flanges 142 are initially placed during mating.

The adapter 120 also includes a drive connector 150 disposed within the housing 121. The drive connector 150 defines an opening 151, as shown in FIGS. 3 and 4, which matingly receives the drive pin 140. The drive connector 150 also includes a geared portion 152. The adapter 120 includes a tool 170, which has a portion that is disposed within the housing 121 and a portion that is disposed outside of the housing 121 substantially along an axis A defined by the drive pin 140. In this embodiment, the tool 170 has a router configuration having blunted surfaces 172 at the tip of the tool 170. The tool 170 is disposed partially within the housing 121 and coupled to a gear assembly 160 within the housing 121. In this embodiment, the gear assembly 160 includes a first gear 161, a second gear 162, and a third gear 163 (best shown in FIG. 4). The gears 161, 162, and 163 are coupled to the tool 170 using pins 166, 165, and 164, respectively. 100351 As described above, the adapter 120 can be removably coupled to the handle assembly 130 using the flanges 142 of the handle assembly 130 and the keyway 122 of the adapter 120. To removably couple the adapter 120 to the handle assembly 130, the flanges 142 can be inserted into the notches 153 of the adapter 120. At the same time, the drive pin 140 is inserted into the opening 151 of the drive connector 150. The adapter 120 can then be rotated relative to the handle assembly 130, for example, 90°, such that the flanges 142 slide within the recess 155 of the keyway 122, locking the adapter 120 to the handle assembly 130. In such a configuration, either the adapter 120 or the handle assembly 130 can be rotated to lock the adapter 120 to the handle assembly 130.

In other embodiments, the configuration of the flanges and the keyway can be reversed. For example, an adapter can include flanges and a handle assembly can include a keyway. As with the previous embodiment, either the adapter or the handle assembly can be rotated to couple the adapter to the handle assembly.

Once the adapter 120 has been coupled to the handle assembly 130, the apparatus 120 can be used to cut or carve a pumpkin, or other like object(s). As described above, when the drive motor 135 is actuated, the drive pin 140 actuates the drive connector 150. When the drive connector 150 is actuated, the geared portion 152 of the drive connector 150 actuates the gear assembly 160, which in turn actuates the tool 170. In this embodiment, the tool 170 actuates in a rotational motion about the axis A. The substantially blunted surfaces 172 of the tool 170 are disposed along the tip of the tool 170 such that when the tool 170 is actuated, the tool 170 can be used to cut, score or bore into a pumpkin shell or other like object.

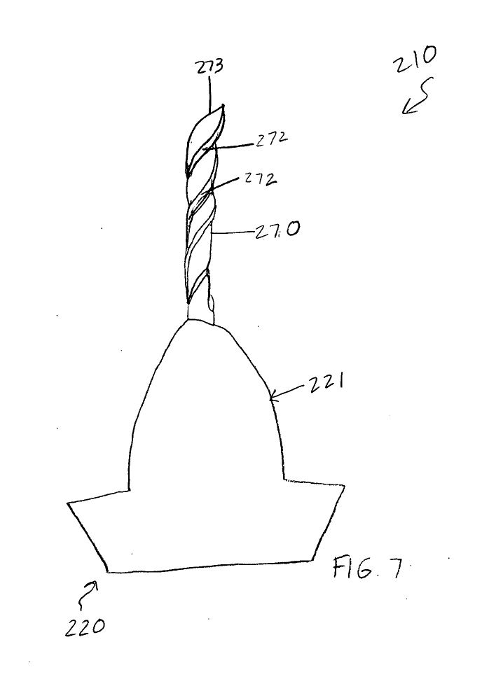

FIG. 7 illustrates an adapter according to another embodiment. An adapter 220 includes many of the same components as the above-described adapter 110, except in this embodiment, the adapter 220 includes a tool 270 having a drill configuration. Thus, the adapter 220 includes a housing 221 that substantially encloses a drive connector (not shown in FIG. 7), and a gear assembly that is coupled to the drive connector (not shown in FIG. 7) that is similar to the gear assembly shown in FIG. 4. The adapter 220 is also configured to be removably coupled to a handle assembly, such as handle assembly 130. The tool 270 extends from the housing 221 substantially along an axis defined by a drive pin of a handle assembly. The tool 270 includes a substantially blunted end portion 273 and multiple substantially blunted surfaces 272 disposed along the tool 270 in a spiral configuration. When the tool 270 is actuated, the drive pin causes the tool 270 to rotate such that the tool 270 can drill a hole into and/or cut a pumpkin shell or other like object.

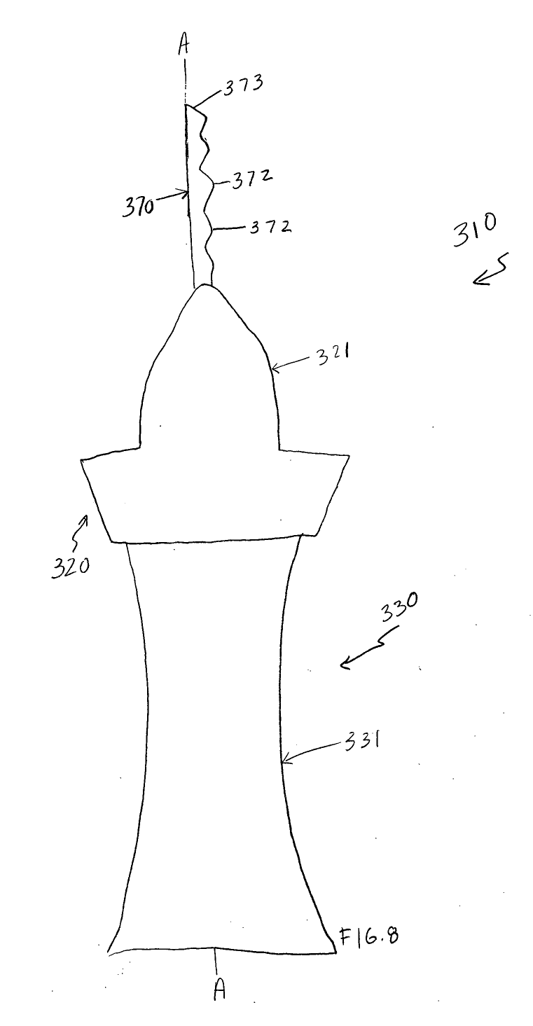

FIGS. 8, 9 and 10 illustrate another carving apparatus according to an embodiment of the invention. An apparatus 310 includes an adapter 320 and a handle assembly 330. The handle assembly 330 can include the same or similar components as the above-described handle assembly 130. The adapter 320 includes a housing 321 that substantially encloses a drive connector 350, a gear assembly 360 coupled to the drive connector 350, and a tool 370. In this embodiment, the housing 321 includes three portions 321′, 321″, and 321′″ that are coupled together to substantially enclose the interior components of the adapter 320.

The drive connector 350 defines an opening 351 matingly coupled to a drive pin (not shown in FIGS. 8-10) on the handle assembly 331. The drive connector 350 also includes a geared portion 352.

In this embodiment, the tool 370 is configured as a saw blade having a substantially blunted end 373 and multiple substantially blunted cutting-surfaces 372 on one side. The tool 370 has a portion that is disposed inside the housing 321 and a portion that is disposed outside the housing 321 substantially along an axis A defined by a drive pin (not shown in FIGS. 8-10) of the handle assembly 330. In another embodiment of the adaptor, the tool 370 can have a substantially blunted end and multiple substantially blunted cutting-surfaces on both sides.

The gear assembly 360 of the adapter 320 has a different configuration than the gear assembly 160 of the adapter 120 and the adapter 220. The gear assembly 360 includes a gear 361 having a cylindrical portion 362 and a barrel portion 367, and an actuating arm 363 that is coupled to the tool 370. The actuating arm 363 includes a housing 369 that defines an elongate opening 355 and a passageway 364 within an interior of the housing 369. A pin 365 couples the cylindrical portion 362 of the gear 361 to the actuating arm 363. The pin 365 is also used to couple the gear assembly 360 to the housing 321. When assembled, the barrel 367 is movably disposed within the passageway 364 of the housing 369, and at least a portion of the cylindrical portion 362 is disposed within the elongate opening 355.

Similar to the operation of the adapter 120 and the adapter 220, when the drive connector 350 is actuated, the geared portion 352 of the drive connector 350 actuates the gear 361 of the gear assembly 360. When the gear 361 is actuated, the gear 361 causes movement of the actuating arm 363. Specifically, the barrel 367 eccentrically rotates about the pin 365 such that the rotation of the barrel 367 translates into longitudinal motion of the actuating arm 363 and tool 370 along a direction defined by the elongate opening 355. Thus, the tool 370 will move in a back-and-forth direction longitudinally in a direction substantially along the axis A.

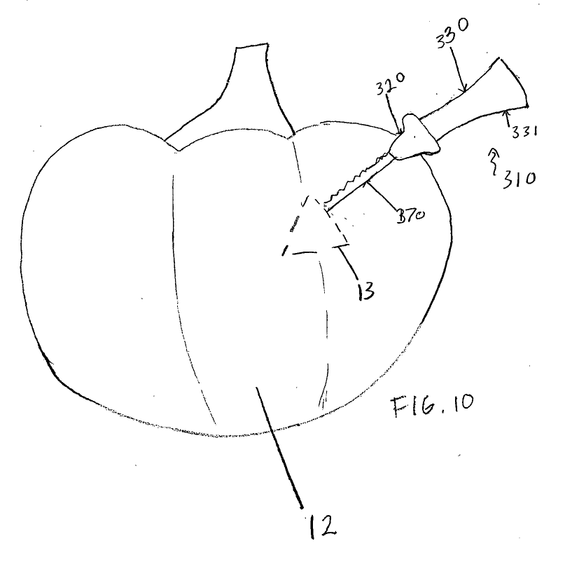

FIG. 10 shows the apparatus 310 in use and inserted into the shell of a pumpkin 12. A user can grasp the housing 331 of the handle assembly 330 and direct the tool 370, for example, to follow a pattern 13.

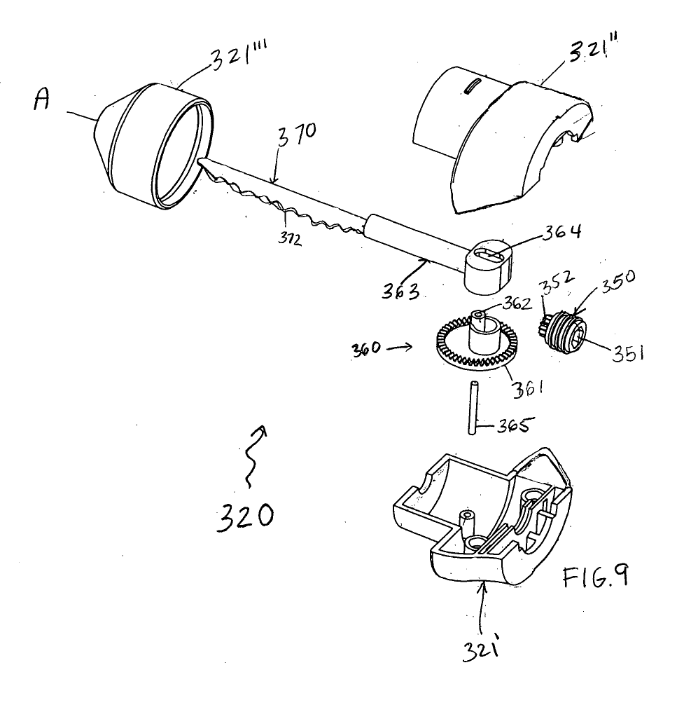

FIG. 11 illustrates an adapter according to another embodiment. An adapter 420 includes many of the same components as the above-described adapter 320, except in this embodiment, the adapter 420 includes a tool 470 having an elongate member configured to reciprocate. Thus, the adapter 420 includes a housing 421 that substantially encloses a drive connector (not shown in FIG. 11), and a gear assembly (not shown in FIG. 11) that is coupled to the drive connector. The gear assembly can be substantially the same as the gear assembly shown in FIG. 9 for the adapter 320. The gear ratio of the gears in the gear assembly can be varied to change the reciprocating speed of the tool 470. For example, in some embodiments, the gears are sized such that the reciprocating speed of the tool 470 is slower than the speed of the tool 370 (saw embodiment). The adapter 420 is also configured to be removably coupled to a handle assembly, such as handle assembly 130. The tool 470 extends from the housing 421 substantially along an axis defined by a drive pin of a handle assembly. The tool 470 includes at least one substantially blunted cutting-surface 472 at an end portion of the tool 470. When the tool 470 is actuated, the tool 470 is configured to reciprocate back and forth similar to the saw blade of adapter 320 except with a shorter range of motion. For example, in one embodiment, the range of motion is 0.25 inches.

Also, in this embodiment, a guide member 480 can be included. The guide member 480 is configured to help guide the tool 470 to a selected location on a pumpkin or other like object. The guide member 480 includes a slot 482 shown in FIG. 12, through which the tool 470 can extend when the tool 470 is actuated. The guide member 482 can be removably coupled to the housing 421. For example, the guide member 482 can be slid over the housing 421 and secured with a friction fit.

The components of an apparatus of the invention can be constructed with a variety of different materials. For example, components such as the housings and the guide member can be constructed with suitable plastic or metal materials. Other components, such as the tool, gear assembly, drive connector, etc. can similarly be constructed with plastics, metals or other suitable materials.

As discussed above, in another embodiment, a kit can be provided including multiple adapters 20 (120, 220, 320, 420) that can be selectively and removably coupled to a single handle assembly 30 (130, 330). Each of the adapters included in the kit can have a different configuration. For example, one adapter can have a tool having a saw blade configuration, while another adapter can have a tool with a drill or router configuration. In some embodiments, multiple adapters may have the same tool configuration, but with different sizes. A user can select from the kit the appropriate adapter to use for the particular cutting, boring, engraving, or scoring function. A kit provides a user a variety of cutting/carving tools from which to select, depending on the particular design to be carved.

For example, to drill a hole in a pumpkin the user may select an adaptor having a tool with a drill bit configuration. To make a cut on a portion of the pumpkin shell, the user may then select an adaptor having a tool with a saw configuration. Thus, the kit allows the user the flexibility to choose the tool best suited for the particular design to be carved in a pumpkin.

### CONCLUSION

While the invention has been particularly shown and described with reference to embodiments thereof, it will be understood that various changes in form and details may be made therein. For example, each of the components of the apparatuses described herein can have a variety of different shapes and sizes other than those illustrated. Also, an adapter can include a variety of different types of tools. For example, a tool may have an end with geared teeth configured to bore a hole in a pumpkin when rotated, or a tool may have a substantially blunted end portion similar to the saw configuration, but with no blunted cutting surfaces along a side.

What is claimed is:

1. An apparatus, comprising:
a handle assembly including a drive motor and a drive pin; and
an adapter configured to removably couple to the handle assembly, the adapter including a drive connector, a gear coupled to the drive connector, and a tool coupled to the gear, the drive connector configured to couple to the drive pin, the tool having at least one substantially blunted cutting-surface, the drive motor being configured to cause movement of the tool such that the tool can be used to cut through a pumpkin shell at less than or equal to a power threshold of 20 horsepower.

2. The apparatus of claim 1, wherein the tool is an elongate member configured to reciprocate, the at least one substantially blunted cutting-surface being at an end portion of the elongate member.

3. The apparatus of claim 1, wherein the tool is a drill bit having a substantially blunted end, the at least one substantially blunted cutting surface including a plurality of substantially blunted cutting surfaces that form a spiral configuration.

4. The apparatus of claim 1, wherein the tool is a saw blade having a substantially blunted end, the at least one substantially blunted cutting surface including a plurality of substantially blunted cutting-surfaces that are positioned along one side of the tool.

5. The apparatus of claim 1, wherein the tool is a router bit having an end portion, the at least one substantially blunted cutting-surface including a plurality of substantially blunted cutting surfaces positioned on the end portion.

6. The apparatus of claim 1, wherein the adapter includes a housing having a keyway, the handle assembly includes a housing having a flange, the flange configured to matingly engage the keyway to removably couple the adapter to the handle assembly when the adapter is rotated.

7. The apparatus of claim 1, wherein the drive pin defines an axis, the adapter includes a housing, the tool having a portion disposed within the housing and a portion disposed outside of the housing substantially along the axis.

8. The apparatus of claim 1, wherein the adapter includes a guide member, the tool is an elongate member configured to reciprocate, the at least one substantially blunted cutting-surface being at a distal end portion of the elongate member, the guide member having an opening through which the distal end portion of the elongate member can move to a selected location on the pumpkin shell.

9. A kit, comprising:
a handle assembly including a drive motor; and
a first adapter configured to be selectively and removably coupled to the handle assembly; and
a second adapter configured to be selectively and removably coupled to the handle assembly, the first adapter and the second adapter each including a housing and a tool coupled to that housing, the tool having at least one substantially blunted cutting-surface,
the drive motor configured to cause movement of the tool of the first adapter when the first adapter is removably coupled to the handle assembly such that the tool of the first adapter can be used to modify a pumpkin shell, the drive motor configured to cause movement of the tool of the second adapter when the second adapter is removably coupled to the handle assembly such that the tool of the second adapter can be used to modify a pumpkin shell.

10. The kit of claim 9, wherein the tool of one of the first adapter or the second adapter is a saw blade having a substantially blunted end and a plurality of substantially blunted cutting-surfaces positioned along one side.

11. The kit of claim 9, wherein the tool of one of the first adapter or the second adapter is a drill bit having a substantially blunted end and a plurality of substantially blunted cutting-surfaces forming a spiral configuration.

12. The kit of claim 9, wherein the tool of one of the first adapter or the second adapter is a router bit having an end portion, the end portion having a plurality of substantially blunted cutting surfaces.

13. The kit of claim 9, wherein the tool of one of the first adapter or the second adapter is a elongate member configured to reciprocate having an end portion, the at least one substantially blunted cutting-surface at the end portion of the elongate member.

14. The kit of claim 9, wherein the handle assembly includes a housing having a flange, the housing of the first adapter includes a keyway, the flange is configured to matingly engage the keyway of the first adapter and removably couple the first adapter to the handle assembly when the first adapter is rotated, the drive motor configured to cause movement of the tool of the first adapter when the first adapter is coupled to the handle assembly.

15. The kit of claim 9, wherein:
the drive motor defines an axis, the handle assembly includes a drive pin coupled to the drive motor substantially along the axis;
the first adapter is configured to removably couple to the drive pin such that the tool of the first adapter has a portion that is disposed outside of the housing substantially along the axis,
the second adapter is configured to removably couple to the drive pin such that the tool of the second adapter has a portion that is disposed outside of the housing substantially along the axis.

16. An apparatus, comprising:
a handle assembly including a drive motor and a drive pin coupled to the drive motor; and
an adapter configured to removably couple to the handle assembly, the adapter including a drive connector, a gear coupled to the drive connector and a router bit member coupled to the gear, the drive connector configured to removably couple to the drive pin, the drive motor configured to cause movement of the router bit member.

17. The apparatus of claim 16, wherein the handle assembly includes a housing having a flange, the adapter includes a housing having a keyway, the flange configured to matingly engage the keyway and removably couple the adapter to the handle assembly when the adapter is rotated.

18. An apparatus, comprising:
a handle assembly including a housing and a drive motor; and
an adapter including a housing, a gear disposed within the housing of the adapter and a tool coupled to the gear, the housing of the adapter including a keyway, the housing of the handle assembly including a flange, the flange configured to matingly engage the keyway and removably couple the adapter to the handle assembly when the adapter is rotated, the drive motor configured to cause movement of the tool when the adapter is coupled to the handle assembly.

19. The apparatus of claim 18, wherein the adapter is configured to rotate substantially 90° to couple the adapter to the handle assembly.

20. The apparatus of claim 18, wherein the tool is a saw blade having a substantially blunted end and a plurality of substantially blunted cutting-surfaces positioned along one side of the tool.

21. The apparatus of claim 18, wherein the tool is a drill bit having a substantially blunted end and a plurality of substantially blunted cutting-surfaces forming a spiral configuration.

22. The apparatus of claim 18, wherein the tool is a router bit having an end portion and a plurality of substantially blunted cutting-surfaces positioned on the end portion.

23. The apparatus of claim 18, wherein the tool is an elongate member configured to reciprocate having an end portion and at least one substantially blunted cutting-surface positioned on the end portion.

24. The apparatus of claim 18, wherein the adapter includes a guide member, the tool is an elongate member configured to reciprocate having an end portion and at least one substantially blunted cutting-surface positioned on the end portion of the elongate member, the guide member having an opening through which the end portion of the elongate member can move to a selected location.

25. A kit, comprising:
a handle assembly including a drive motor; and
a first adapter configured to be selectively and removably coupled to the handle assembly, the first adapter including saw blade having a plurality of substantially blunted cutting surfaces;
a second adapter configured to be selectively and removably coupled to the handle assembly, the second adapter including a router bit having a plurality of substantially blunted cutting surfaces;
a third adapter configured to be selectively and removably coupled to the handle assembly, the third adapter including a drill bit having a plurality of substantially blunted cutting surfaces; and
a fourth adapter configured to be selectively and removably coupled to the handle assembly, the fourth adapter including an elongate member configured to reciprocate having at least one substantially blunted cutting surface.

26. The kit of claim 25, wherein the first adapter, the second adapter, the third adapter and the fourth adapter each include a housing having a keyway, the handle assembly includes a housing having a flange, the flange of the handle assembly configured to matingly engage a keyway of a selected one of the first adapter, the second adapter, the third adapter and the fourth adapter to removably couple the selected one of the first adapter, the second adapter, the third adapter and the fourth adapter to the handle assembly.
